(19) United States
(12) Patent Application Publication
(10) Pub. No.: US 2016/0191877 A1
(43) Pub. Date: Jun. 30, 2016

(54) PROJECTOR DEVICE AND PROJECTION METHOD

(71) Applicant: Panasonic Intellectual Property Management Co., Ltd., Osaka (JP)

(72) Inventor: KEIGO ONO, Osaka (JP)

(21) Appl. No.: 14/938,783

(22) Filed: Nov. 11, 2015

(30) Foreign Application Priority Data
Dec. 25, 2014 (JP) 2014-263588
Oct. 27, 2015 (JP) 2015-210900

(51) Int. Cl. H04N 9/31; G06T 7/00

(52) U.S. Cl. CPC H04N 9/3185; H04N 9/3194; G06T 7/004; G06T 7/0083

(57) ABSTRACT

The present disclosure can provide a projector device which includes: a distance sensor which measures a distance to a facing object, a detector which detects a specific target object and a projection plane which is in contact with the target object, based on distance information output from the distance sensor, a projection region determination unit which specifies a contact portion at which the target object and the projection plane are in contact, and determines a region on which a video image which is associated with the target object can be projected, in the projection plane based on the specified contact portion, and a projector which projects the video image to the region, and which can reliably project video images in a region having an intended positional relationship with a specific object.

### BACKGROUND

1. Technical Field

The present disclosure relates to a projector device and a projection method.

2. Description of the Related Art

Unexamined Japanese Patent Publication No. 2013-235374 discloses a device which recognizes an object included in an image acquired by using an imaging device, and projects a video image near the recognized object.

According to a method disclosed in Unexamined Japanese Patent Publication No. 2013-235374, the imaging device recognizes an object based on a captured image, and projects the video image based on the recognition. In this regard, an image generated by the imaging device is an image generated by projecting on a two-dimensional space a subject a so-called true three-dimensional space. It is not possible to acquire information related to a depth direction. in the true three-dimensional space from such an age. Hence, the method disclosed in Unexamined Japanese Patent Publication No. 2013-235374 has a problem that, when an object is placed on a plane which is oblique with respect to a device, and even when a video image is projected near a recognized object, a video image is actually projected at a position away from the object.

### SUMMARY

The present disclosure provides a projector device which reliably projects video images in a region having an intended positional relationship with a specific object.

A projector device according to the present disclosure includes a distance sensor which measures a distance to a facing object, a detector which detects a specific target object and a projection plane which is in contact with the target object, based on distance information output from the distance sensor, a projection region determination unit which specifies a contact portion at which the target object and the projection plane are in contact, and determines a region on which a video image which is associated with the target object can be projected, in the projection plane based on the specified contact portion, and a projector which projects the video image to the region.

The projector device according to the present disclosure reliably projects video images in a region having an intended positional relationship with a specific object.

### BRIEF DESCRIPTION OF DRAWINGS

FIG. 1 is a schematic view illustrating a situation that a projector device projects a video image on a wall surface on which a painting is hung;

FIG. 2 is a schematic view illustrating a situation that the projector device projects a video image on a table on which a PET bottle is placed;

FIG. 3 is a block diagram illustrating an electric configuration of the projector device;

FIG. 4A is a block diagram illustrating an electric configuration of a distance detector;

FIG. 4B is a view for explaining distance information acquired by the distance detector;

FIG. 5 is a block diagram illustrating an optical configuration of the projector device;

FIG. 6 is a schematic view for explaining items of data held in a memory;

FIG. 7A is a view illustrating details of a video image setting reference table;

FIG. 7B as a view illustrating details of a target object shape database;

FIG. 7C is a view illustrating details of a projection content database;

FIG. 8 is a view for explaining a problem that a video image cannot be reliably projected near an object;

FIG. 9 is a flowchart of a video image projecting operation;

FIG. 10 is a flowchart illustrating details of projection region search processing;

FIG. 11 is a schematic view for explaining acquisition of plane information of a projection plane;

FIG. 12 is a schematic view illustrating detection of contact points of a target object and a projection plane;

FIG. 13 is a schematic view for explaining search for a projection region;

FIG. 14 is a schematic view illustrating a situation that a video image is projected at an intended position associated with a target object (PET bottle);

FIG. 15 is a schematic view illustrating another example of a projection video image; and

FIG. 16 is a schematic view illustrating another example of a projection video image.

### DETAILED DESCRIPTION

Exemplary embodiments will be described in detail below optionally with reference to the drawings. In this regard, the exemplary embodiments will not be described in detail more than necessary in some cases. For example, matters which are already well-known will not be described in detail, and overlapping description of substantially same components will be omitted. This is to prevent the following description from being unnecessarily redundant and help one of ordinary skill in the art understand the present disclosure.

In addition, the applicant provides the accompanying drawings and the following description to help one of ordinary skill in the art sufficiently understand the present disclosure, and does not intend to limit a subject matter of the claims.

### First Exemplary Embodiment

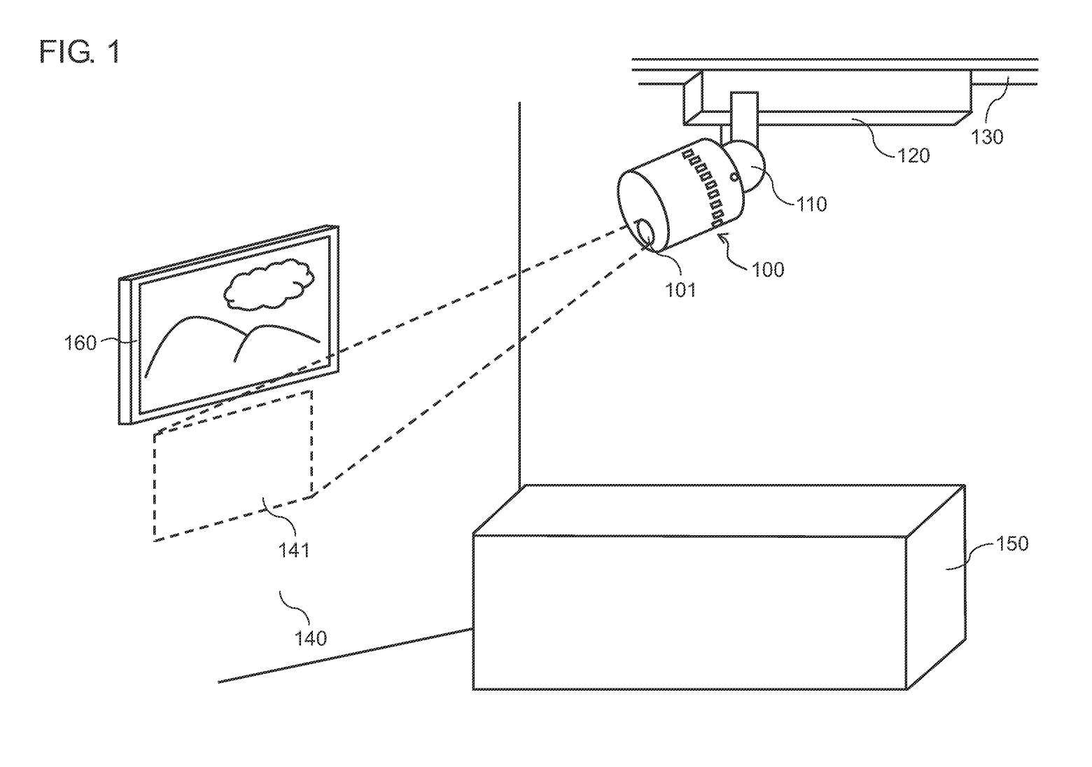

The first exemplary embodiment will be described below with reference to FIGS. 1 to 16, Projector device 100 which is a projector device according to a specific exemplary embodiment of the present disclosure will be described below.

[1-1. Outline]

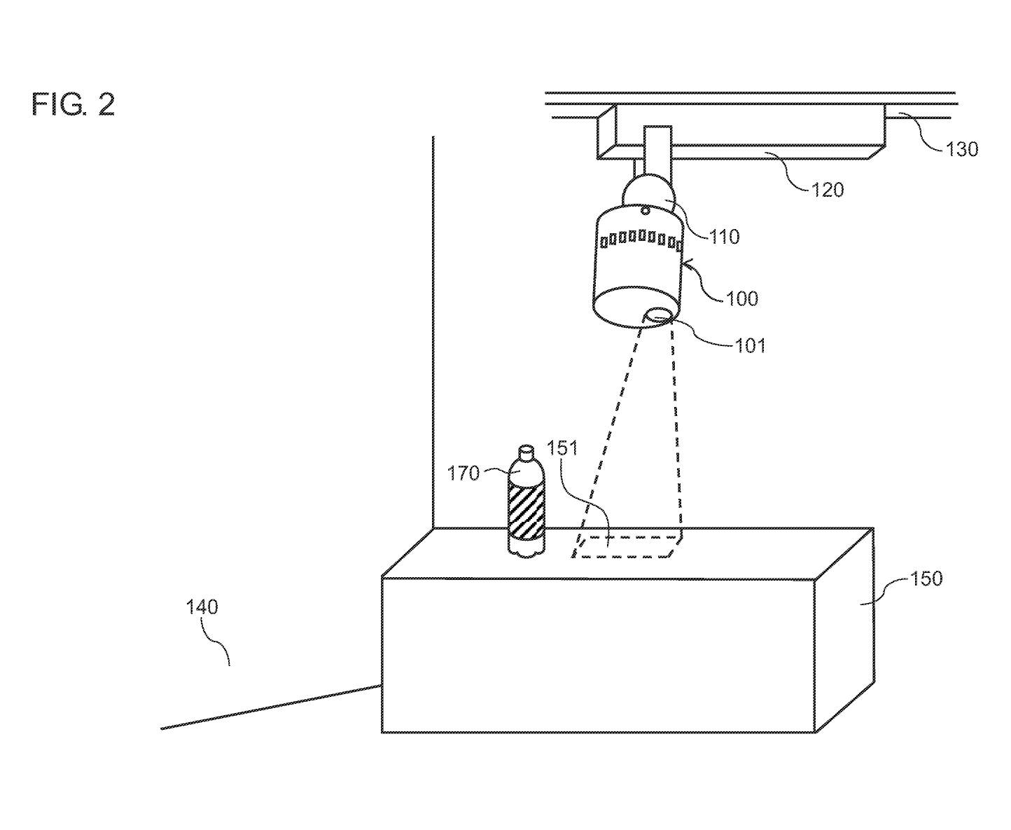

An outline of a video image projecting operation of projector device 100 will be described with reference to FIGS. 1 and 2. FIG. 1 is an image view illustrating that projector device 100 projects a video image on wall 140. FIG. 2 is an image view illustrating that projector device 100 projects a video image on table 150.

As illustrated in FIGS. 1 and 2, projector device 100 and drive unit 110 are fixed to housing 120. Wirings which are electrically connected with each unit which configures projector device 100 and drive unit 110 are connected to a power supply through housing 120 and wiring duct 130. Thus, power is supplied to projector device 100 and drive unit 110. Projector device 100 includes opening 101. Projector device 100 projects video images through opening 101.

Drive unit 110 can drive projector device 100 to change a projection direction of projector device 100. Drive unit 110 can drive projector device 100 to change the projection direction of projector device 100 to a direction of wall 140 as illustrated in FIG. 1. Thus, projector device 100 can project video image 141 on wall 140 on which painting 160 is hung. Similarly, drive unit 110 can drive projector device 100 to change the projection direction of projector device 100 to a direction of table 150 as illustrated in FIG. 2. Thus, projector device 100 can project video image 151 on table 150 on which PET (an abbreviation of polyethylene terephthalate) bottle (hereinafter, referred to as a PET) 170 is placed. Drive unit 110 may drive projector device 100 according to a user's manual operation or may automatically drive projector device 100 according to a predetermined sensor detection result. Further, contents of video image 141 projected on wall 140 and video image 151 projected on table 150 may be different or the same.

Object detector 200 is mounted on projector device 100. Thus, projector device 100 can detect presence of a specific object, and can project a video image on a region in a projection plane having an intended positional. relationship with the detected object.

[1-2. Configuration]

A configuration and an operation of projector device 100 will be described in detail below.

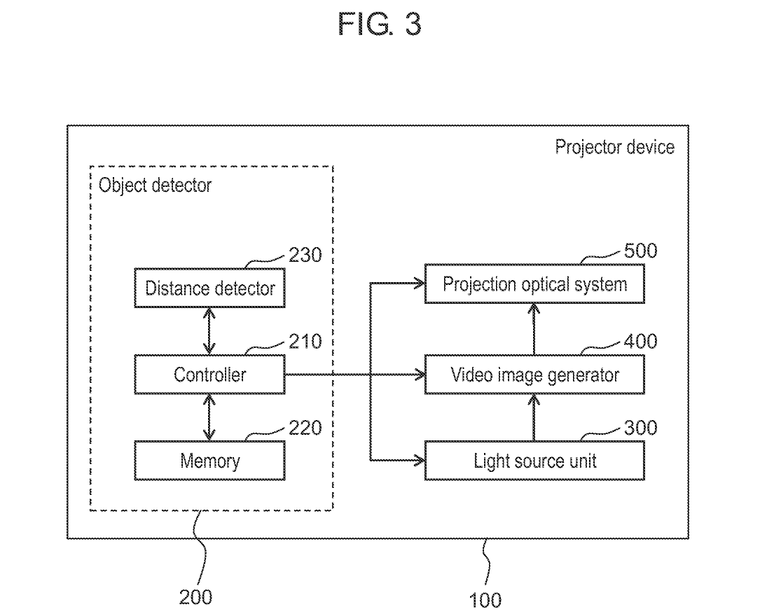

FIG. 3 is a block diagram illustrating an electric configuration of projector device 100. Projector device 100 includes object detector 200, light source unit 300, video image generator 400 and projection optical system 500. Further, object detector 200 includes controller 210, memory 220 and distance detector 230. A configuration of each unit which configures projector device 100 will be described in order below.

Controller 210 is a semiconductor element which controls entire projector device 100. That is, controller 210 controls operations of each unit (distance detector 230 and memory 220) which configures object detector 200, light source unit 300, video image generator 400 and projection optical system 500. Further, controller 210 can perform digital zoom control of reducing/enlarging a projection image by video signal processing, and geometrically correct a projection video image by taking into account an orientation of the projection plane. Controller 210 may be configured by hardware alone or may be realized by combining hardware and software.

Memory 220 is a memory element which stores various pieces of information. Memory 220 is configured by a flash memory or a ferroelectrics memory. Memory 220 stores, for example, a control program for controlling projector device 100. Further, memory 220 stores various pieces of information supplied from controller 210. Furthermore, memory 220 stores image data (still images and moving images) of video images to be projected, a reference table including settings such as positions at which video images need to be projected and projection sizes, and data of shapes of object detection target objects.

Distance detector 230 is configured by, for example, a TOF (Time-of-Flight) distance age sensor (hereinafter, referred to as a TOF sensor). The TOF sensor applies a near infrared ray, detects reflected light of the near infrared ray and measures a distance, and linearly detects a distance to the facing projection plane or object. When distance detector 230 faces wall 140, the TOF sensor detects a distance from distance detector 230 to wall 140. When painting 160 is hung on wall 140, distance detector 230 can detect a distance to a surface which faces painting 160, too. Similarly, when distance detector 230 faces table 150, the TOF sensor detects a distance from distance detector 230 to table 150. When PET bottle 170 is placed on table 150, distance detector 230 can detect a distance to a surface which faces PET bottle 170, too.

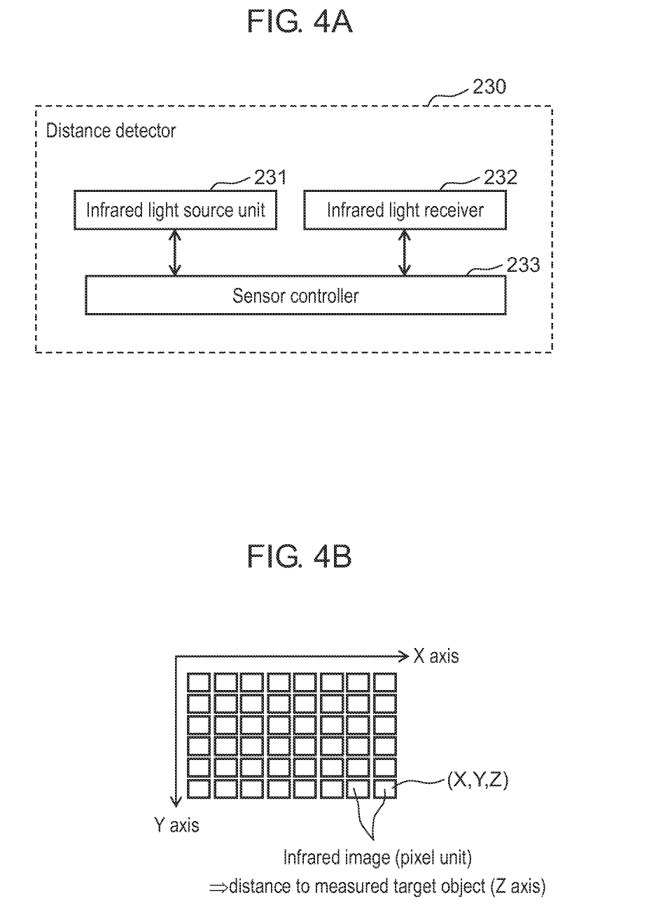

FIG. 4A is a block diagram illustrating an electric configuration of distance detector 230. As illustrated in FIG. 4A, distance detector 230 includes infrared light source unit 231 which applies infrared detection light, infrared light receiver 232 which receives infrared detection light reflected by a surface which faces table 150 or PET bottle 170, and sensor controller 233 which controls infrared light source unit 231 and infrared light receiver 232. Infrared light source unit 231 applies infrared detection light through opening 101 such that the infrared detection light is diffused all around. Infrared light source unit 231 uses infrared light having a wavelength of 850 nm to 950 nm as infrared detection light. Sensor controller 233 stores in the memory a phase of the infrared detection light applied from infrared light source unit 231. When the facing surface is not at an equal distance from distance detector 230 and has an inclination or a shape, a plurality of pixels aligned on an imaging plane of infrared light receiver 232 receives reflected light at each different timing. The reflected light is received at different timings, and therefore the infrared detection light received by infrared light receiver 232 has a different phase per pixel. Sensor controller 233 stores in the memory a phase of the infrared detection light received by each pixel of infrared light receiver 232.

Sensor controller 233 reads from the memory a phase of the infrared detection light applied from infrared light source unit 231 and a phase of the infrared detection light received by each pixel of infrared light receiver 232. Sensor controller 233 can measure a distance from distance detector 230 to the facing surface based on a phase difference between the infrared detection light applied from infrared light source unit 231 and the infrared detection light received by infrared light receiver 232.

FIG. 4B is a view for explaining distance information acquired by infrared light receiver 232 of distance detector 230. Distance detector 230 detects a distance to an object which has reflected the infrared detection light based on the above phase difference of each of the pixels which configures an infrared image of the received infrared detection light. Thus, controller 210 can obtain in pixel units a distance detection result of an entire field angle of the infrared image received by distance detector 230. As illustrated in FIG. 4B, a horizontal direction of an infrared image is an X axis, and a vertical direction is a Y axis. Further, when a detected distance takes a value on a Z axis, controller 210 can acquire coordinates of three X, Y and Z axes (X, Y Z) of each pixel which configures an infrared image based on the detection result of distance detector 230. That is, controller 210 can acquire distance information based on the detection result of distance detector 230. Controller 210 can calculate coordinate values (x, y, z) (an original point is arbitrary) of an object surface of a triaxial orthogonal coordinate system from the distance information (X, Y, Z).

Controller 210 detects the projection plane (e.g. a top plate of wall 140 or table 150) or a specific object (painting 160 or PET bottle 170) based on the distance information (X, Y, Z) or the coordinate values (x, y z).

Distance detector 230 has been described as the TOF sensor above. However, the present disclosure is not limited to this. That is, a distance may be calculated from misalignment of a pattern by projecting the known pattern such as a random dot pattern or may be calculated by using a parallax of a stereo camera. Further, projector device 100 may include distance detector 230 (TOF) and, in addition, an RGB camera which is riot illustrated. In this case, projector device 100 may detect an object by using image information output from the RGB camera together with distance information output from the TOF sensor. By using the ROB camera in combination, it is possible to detect an object by using information of a three-dimensional shape of an object acquired from distance information and information such as a color of air object or characters written on the object.

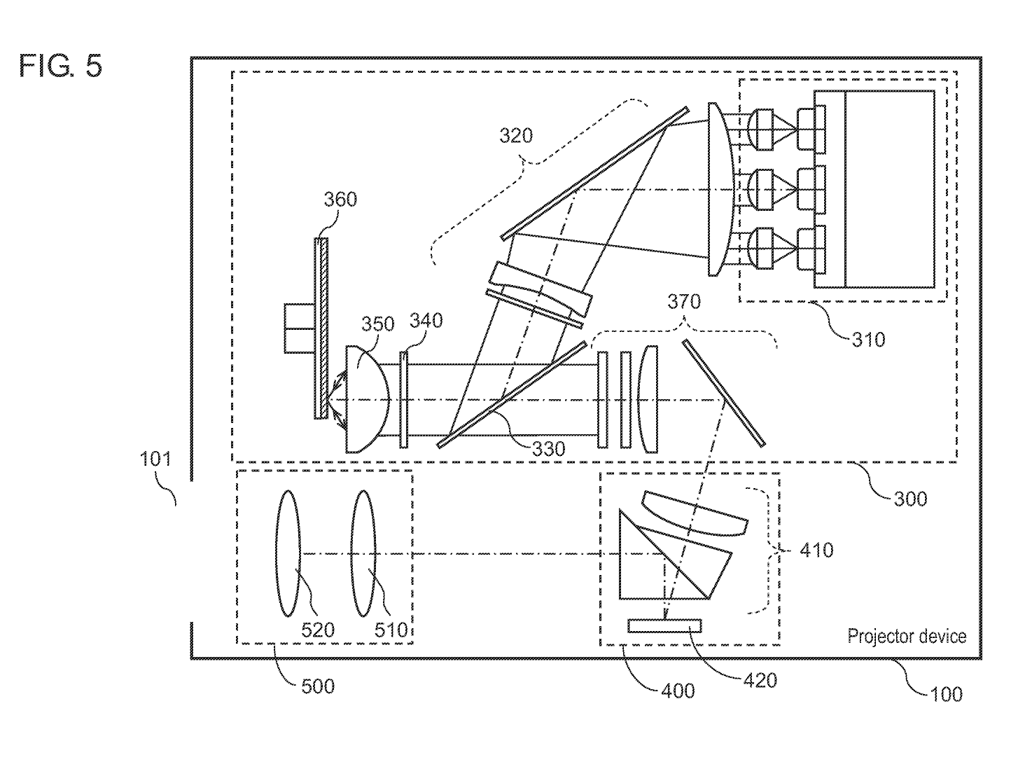

Next, configurations of light source unit 300 video image generator 400, and projection optical system 500 will be described with reference to FIG. 5. FIG. 5 is a block diagram illustrating an optical configuration of projector device 100. As illustrated in FIG. 5, light source unit 300 supplies light which is necessary to generate a projection video image, to video image generator 400. Video image generator 400 supplies the generated video image to projection optical system 500. Projection optical system 500 performs optical conversion such as focusing or zooming on a video image supplied from video image generator 400. Projection optical system 500 faces opening 101, and receives a video image projected from opening 101.

First, the configuration of light source unit 300 will be described. As illustrated in FIG. 5, light source unit 300 includes semiconductor laser 310, dichroic mirror 300, λ/4 plate 340 and phosphor wheel 360.

Semiconductor laser 310 is a fixed light source which emits blue light of S-polarized light having a wavelength of 440 nm to 455 nm. The blue light of the S-polarized light emitted from semiconductor laser 310 is incident on dichroic mirror 330 through light guide optical system 320.

Dichroic mirror 330 is an optical element which has a high reflectivity of 98% or more with respect to blue light of S-polarized light having a wavelength of 440 nm to 455 nm, and which has a high transmittance of 95% or more with respect to blue light of P-polarized light having a wavelength of 440 nm to 455 nm and green light to red light having a wavelength of 490 nm to 700 nm irrespectively of a polarization state. Dichroic mirror 330 reflects the blue light of the S-polarized light emitted from semiconductor laser 310, to a direction of λ/4 plate 340.

λ/4 plate 340 is a polarizing element which converts linearly polarized light into circularly polarized light or converts circularly polarized light into linearly polarized light. λ/4 plate 340 is disposed between the dichroic mirror and the phosphor wheel. The blue light of the S-polarized light having been incident on 214 plate 340 is converted into blue light of circularly polarized light, and then is applied on phosphor wheel 360 through lens 350.

Phosphor wheel 360 is an aluminum flat plate which is configured to rotate at a high speed. On a surface of phosphor wheel 360, a plurality of B regions which is regions of a diffusion reflection surface, G regions to which phosphors which emit green light have been coated and R regions to which phosphors which emit red light have been coated are formed. The blue light of the circularly polarized light having been applied on each B region of phosphor wheel 360 is diffused and reflected, and is incident as the blue light of the circularly polarized light on λ/4 plate 340 again. The blue light of the circularly polarized light having been incident on λ/4 plate 340 is converted into blue light of P-polarized blue light, and is incident on dichroic mirror 330 again. The blue light having been incident on dichroic mirror 330 transmits through. dichroic mirror 330 since the blue light is the P polarized light, and is incident on video image generator 400 through light guide optical system 370.

The blue light applied on each G region or each R region of phosphor wheel 360 excites the phosphor coated to each G region or each R region, and causes the phosphor to emit green light or red light. The green light or the red light emitted from each G region or each R region is incident on dichroic mirror 330. The green light or the red light having been incident on dichroic mirror 330 transmits through dichroic mirror 330, and is incident on video image generator 400 through light guide optical system 370.

Since phosphor wheel 360 is rotating at a high speed, the blue light, the green light and the red light are emitted by way of time division from light source unit 300 to video image generator 400.

Video image generator 400 generates a projection video image corresponding to a video image signal supplied from controller 210. Video image generator 400 includes DMD (Digital-Mirror-Device) 420 or the like. DMD 420 is a display element formed by aligning multiple micromirrors on a plane. DMD 420 deflects each of the aligned micromirrors according to a video signal supplied from controller 210, and spatially modulates incident light. Light source unit 300 emits blue light, green light and red light by way of time division. DMD 420 repeatedly receives the blue light, the green light and the red light emitted in order by way of time division through light guide optical system 410. DMD 420 deflects each of the micromirrors in synchronization with a timing at which each light of a color is emitted. Thus, video image generator 400 generates a projection video image corresponding to a video image signal. DMD 420 deflects the micromirrors toward light which is caused to travel toward projection optical system 500, and light which is caused to travel to an outside of an effective range of projection optical system 500 according to a video image signal. Thus, video image generator 400 can supply the generated projection video image to projection optical system 500.

Projection optical system 500 includes optical members such as zoom lens 510 and focus lens 520. Projection optical system 500 enlarges the light having been incident from video image generator 400, and projects the light on the projection plane. Controller 210 can control a projection region of a projection target to obtain a desired zoom value by adjusting a position of zoom lens 510. When the zoom value s increased, controller 210 moves the position of zoom lens 510 in a direction in which the field angle narrows, and narrows the projection region. Meanwhile, when the zoom value is decreased, controller 210 moves the position of zoom lens 510 in a direction in which the field angle widens, and widens the projection region. Further, controller 210 can adjust a focus of the projection video image by adjusting the position of focus lens 520 based on predetermined zoom tracking data to follow movement of zoom lens 510.

A configuration of a DLP (Digital-Light-Processing) mode which uses DMD 420 has been described as an example of projector device 100. However, the present disclosure is not limited to this. That is projector device 100 may adopt a configuration of a liquid crystal mode.

A configuration of a single-plate mode which uses light sources using phosphor wheel 360 by way of time division has been described as an example of projector device 100. However, the present disclosure is not limited to this. That is, projector device 100 may employ a configuration of a three-plate mode including various light sources of blue light, green light and red light.

A configuration where a light source of blue light which generates a projection video image and a light source of infrared light which measures a distance are provided, as different units has been described above. However, the present disclosure is not limited to this. That is, the light source of blue light which generates a projection video image and a light source of infrared light which measures a distance may be integrated as one unit. When the three-plate mode is adopted, the light source of each color and the light source of infrared light may also be integrated as a unit.

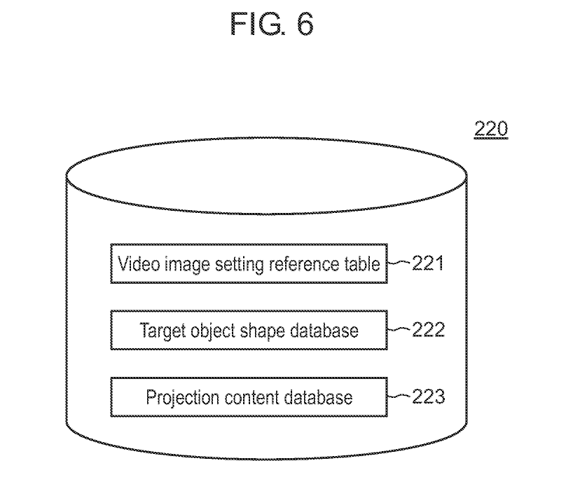

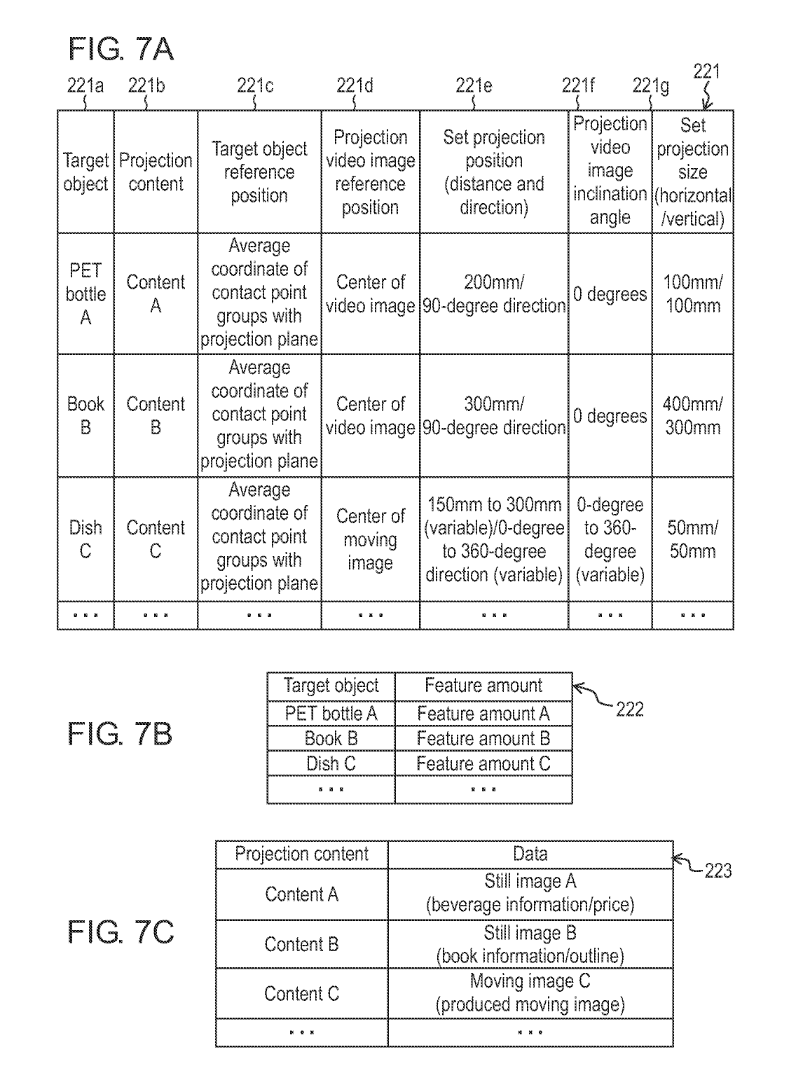

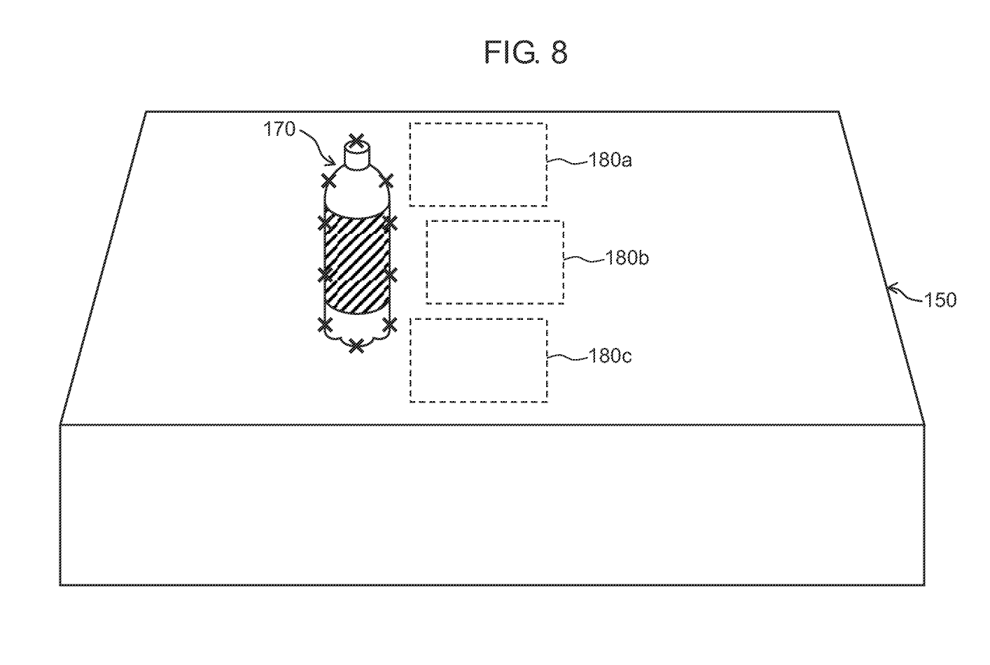

Next, data held in memory 220 of object detector 200 will be described with reference to FIGS. 6 and 7.

FIG. 6 is a schematic view illustrating three types of items of data held in memory 220. Memory 220 holds video image setting reference table 221, target object shape database 222 and projection content database 223.

Video image setting reference table 221 is a reference table which indicates setting information such as positions at which video images need to be projected, and projection sizes of a specific target object.

FIG. 7A is a view illustrating details of video image setting reference table 221. Video image setting reference table 221 associates and manages target object 221a projection content 221b, target object reference position 221c, projection video image reference position 221d. setting projection position 221e, projection video image inclination angle 221f and set projection size 221g.

Target object 221a is information indicating a target object which needs to be detected by object detection. FIG. 7A illustrates that information indicating target objects such as “PET bottle A”, “hook B” and “dish C” is managed.

Projection content 221b is information related to a video image which needs to be projected when a target object is detected. This information includes a link with video image data held in projection content database 223. FIG. 7A illustrates that information indicating projection video images such as items of content A, B and. C is managed.

Target object reference position 221c is information which defines a reference position of a target object side which is used to determine a position at which a video image associated with a target object detected by object detection is projected. In the present exemplary embodiment, a projection video image is displayed in a partial region in the projection plane which has a predetermined relative positional relationship with a target object. A “target object reference position” is used as a reference point at a target object side having the above predetermined relative positional relationship. In case of, for example, the target object “PET bottle A” an average value of coordinate values of contact point groups of “PET bottle A” and the projection plane is a reference position at the target object side having the above relative positional relationship.

Projection video image reference position 221d is information which defines a reference position at a projection video image side having the above relative positional relationship. In case of, for example, the target object “PET bottle A”, a video image is projected such that an average coordinate (“target object reference position”) of contact point groups of “PET bottle A” and the projection plane, and a center (“projection video image reference position”) of a video image associated with “PET bottle A” have a predetermined relative positional relationship.

Set projection position 221e is information which defines the above predetermined relative positional relationship. That is, set projection position 221e manages information related to the relative positional relationship which a target object reference position and a reference position of a projected video image need to satisfy. In addition, a plurality of relative positional relationships may be set to one target object. In this case, a plurality of set relationships can also be prioritized.

In case of, for example, the target object “PET bottle A”, it is defined that a positional relationship between the average coordinate (“target object reference position”) of the contact point groups of “PET bottle A” and the projection plane, and the center (“projection video image reference position”) of a video image associated with target object “PET bottle A” is such a relative positional relationship that there is a distance of 200 mm away from “target object reference position” in a 90-degree direction. In addition, the 90-degree direction refers to a direction at 90 degrees in a clockwise direction when, for example, a predetermined direction is zero degrees. The predetermined direction may be, for example, a minus Y axis direction of distance information (distance image) output from distance detector 230 (FIG. 4B).

Further, in case of, for example, target object “dish C”, a direction of a projection video image seen from “target object reference position” and a distance having a margin are defined. That is, it is defined that a position at which a video image associated with the target object “dish C” may be variable. As to the video image associated with the target object “dish C” a distance between a projection video image reference position and a target object reference position is variable in a range of 150 mm to 300 mm, and a direction of a projection video image reference position seen from the target object reference position is also variable in a range of 0 degrees to 360 degrees. In this case, the video image may be projected by changing a projection place such that the video image is included in the range.

Projection video image inclination 221f is information which defines an inclination angle of a video image when a video image is projected on the projection plane.

Set projection size 221g is information which defines a size of a video image on the projection plane when the video image is projected on the projection plane.

FIG. 7B is a view illustrating details of target object shape database 222. Target object shape database 222 is a database which holds data indicating a feature amount of a shape per target object.

FIG. 7C is a view illustrating details of projection content database 223. Projection content database 223 is a database which holds data of each projection content (still images or moving images) and information indicating an outline of each projection content.

[1-3. Operational]

Next, an operation of object detector 200 mounted on projector device 100 will be described.

First, a problem caused when an object is detected and a video image is projected near the detected object will be described with reference to FIG. 8. For example, a case where PET bottle 170 placed on table 150 is detected by using a color image captured by the normal RGB camera, and a video image is projected near PET bottle 170 will be described. FIG. 8 is a view illustrating that table 150 on which PET bottle 170 is placed is seen from a projector device side. First, PET bottle 170 is detected by using a technique of recognizing an object based on a color image captured by the RGB camera. In this case, it is not possible to determine, from a color image, at which part of an outline of PET bottle 170 (symbols x in FIG. 8), PET bottle 170 and table 150 which is the projection plane are in contact.

Hence, when a cap at an upper end of PET bottle 170 is used as a reference to project a video image near the cap, the video image is eventually projected around region 180a. In this case, a position at which PET bottle 170 is placed and a position at which the video image is projected are actually apart greatly from each other.

Further, when a body portion of PET bottle 170 is used as a reference to project a video image near the body portion, the video image is eventually projected around region 180b. In this case, too, a position at which PET bottle 170 is placed and a position at which the video image is projected are apart from each other.

To project a video image near PET bottle 170, a video image is desirably projected near a bottom portion of PET bottle 170, i.e., region 180c near a portion at which PET bottle 170 is in contact with table 150.

However, it is not possible to determine, from a color image output from the normal RGB camera, which portion of PET bottle 170 is in contact with table 150. Therefore, a configuration of detecting an object based on a normal color image has difficulty in reliably projecting a video image near the detected object.

Hence, the inventor invented a technical idea that projector device 100 specifies a contact portion at which an object and a projection plane are in contact, based on distances to the object and the projection plane, and determines a region on which the video image needs to be projected, based on the contact portion.

An operation from object detection to video image projection performed by projector device 100 according to the present exemplary embodiment will be described below.

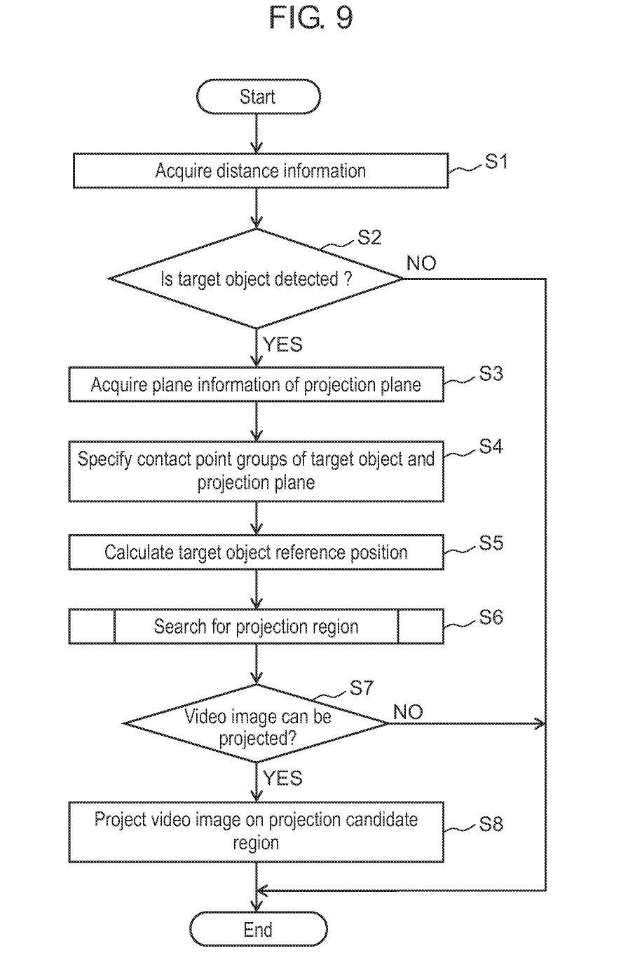

FIG. 9 is a flowchart illustrating a flow of the operation of projector device 100.

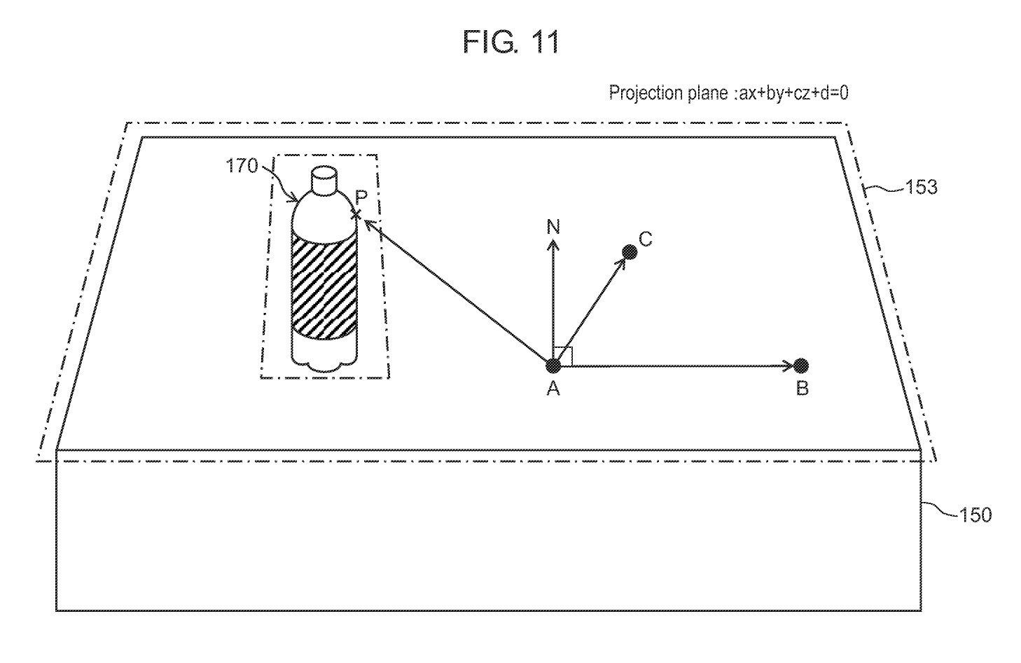

Controller 210 of projector device 100 acquires distance information from distance detector 230 (step S1). Controller 210 detects a target object (e.g. PET bottle 170) and the projection plane (e.g. table 150) based on the distance information. More specifically, controller 210 detects a target object and the projection plane from the distance information by performing matching processing on the distance information (distance image) based on target object shape database 222 held in memory 220. More specifically, controller 210 detects the target object by detecting from the distance image an object indicated by each feature amount registered in database 222. In an example illustrated in FIG. 11, top plate 153 of table 150 which is the projection plane and PET bottle 170 which is a target object are detected by controller 210.

In addition, controller 210 may detect the target object and the projection plane by acquiring the distance information and, in addition, a color image from the RGB camera which is not illustrated, and performing matching processing based on the color image. Further, the matching processing may be performed based on statistical target object shape data by machine learning or the like.

Controller 210 determines whether or not the target object has been detected (step S2). In a case where the target object has been detected (“YES” in step S2), processing proceeds to step S3. In a case where the target object has not been detected (“NO” in step S2), the processing is finished.

In a case where the target object has been detected, controller 210 next acquires plane information of the projection plane based on the distance information. More specifically, controller 210 derives a plane equation of the projection plane based on the distance information (step S3).

A method for deriving the plane equation will be described with reference to FIG. 11. Controller 210 selects arbitrary three points of point A, point B and point C on the projection plane (top plate 153 of table 150), calculates coordinate values of point A, point B and point C on the triaxial orthogonal coordinate system (x, y, z) based on the distance information, and forms vector AB and vector AC. Further, controller 210 calculates exterior product vector N of vector AB and vector AC. Controller 210 determines plane equation ax+by+cz+d=0 of the projection plane based on exterior vector N and a coordinate value such as point A. Information (i.e., coefficients a, b, c and d) of the plane equation of the projection plane derived in this way are held in memory 220.

In addition, a case where a target object is detected and then a plane equation is derived has been described above. However, the present disclosure is not limited to this. That is, the plane equation of a plane (top plate 153 of table 150) on which a target object is scheduled to be placed may be derived prior to detection of a target object. Alternatively, even when a target object is detected and then a plane equation is derived, distance information to which a reference is made may be acquired prior to detection of the target object. In this case, coordinate values of three arbitrary points of point A, point B and point C need to be acquired based on distance information of a plane (top plate 153 of table 150) on which a target object is scheduled to be placed before the target object is detected, and to be stored in memory 220.

Back to FIG. 9, controller 210 specifies portions at which the target object and the projection plane are in contact, i.e., contact paint groups (step S4).

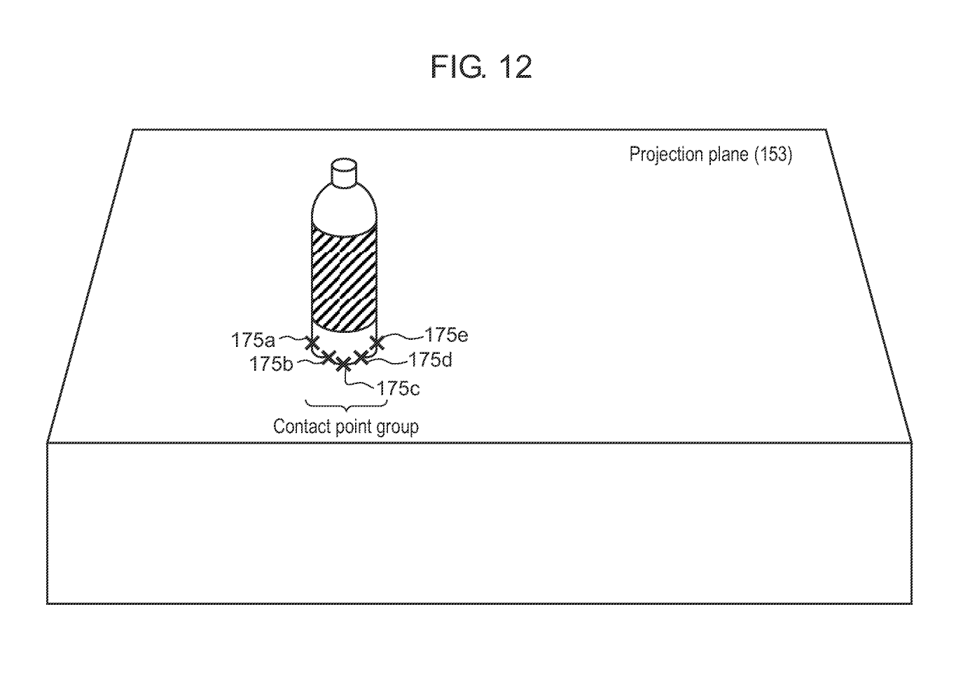

A method for specifying contact point groups will be described with reference to FIGS. 11 and 12. Controller 210 calculates from distance information a coordinate value of a point (e.g. point P) which forms the outline of PET bottle 170 which is a target object. Further, controller 210 calculates a vector (e.g. vector AP) from one arbitrary point of projection plane 153 (e.g. point A) to point P. Furthermore, controller 210 calculates an absolute value of an inner product of vector AP and a unit vector of length l which is elongated in a normal direction of projection plane 153 via point A. This absolute value represents a distance between point P and projection plane 153. When a value of the inner product (i.e., a distance between point P and projection plane 153) is zero or is less than a predetermined value (e.g. less than 5 millimeters of a distance), controller 210 determines point P as a contact point of the target object (PET bottle 170) and the projection plane (top plate 153 of table 150).

In addition, after the processing in step S4, controller 210 may verify whether or not the plane equation derived in step S3 is correct. For example, when controller 210 cannot determine in step S4 that the value of the inner product is a predetermined value or more and there is a contact point, controller 210 may determine that the plane equation is wrong, select coordinate values of three arbitrary points of point A, point B and point C again, and recalculates the plane equation. Thus, at least one coordinate value of three arbitrary points of point A, point B and point C is acquired from a position other than a plane (top plate 153 of table 150) on which a target object is scheduled to be placed, so that, even when a wrong plane equation is calculated, it is possible to correct the wrong plane equation to a correct plane equation. In addition, step S3 of verifying whether or not the derived plane equation is correct may be repeated until the plane equation which can be determined as the correct plane equation can be derived. Further, when the plane equation which can be determined as the correct plane equation cannot be derived even after the verification is repeated a predetermined number of times, an error may be notified.

Thus, controller 210 determines whether or not each point which forms an outline of a target object is a contact point with the projection plane to specify a portion at which the target object and the projection plane are in contact. FIG. 12 is a view illustrating contact point groups 175a to 175e calculated in this way.

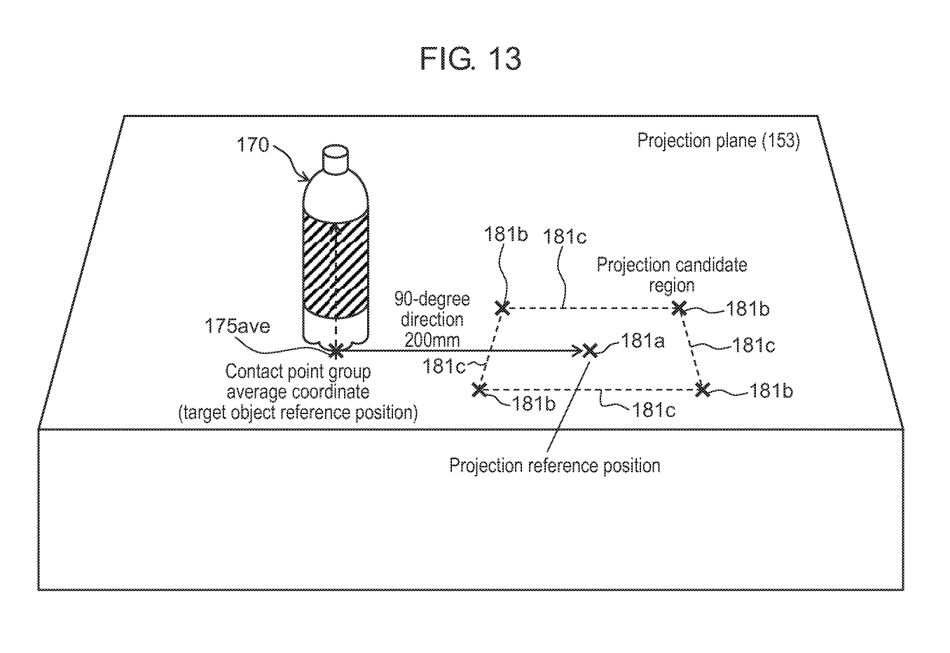

Back to FIG. 9, controller 210 calculates a coordinate value of a target object reference position (step S5). In this case, controller 210 first refers to video image setting reference table 221 held in memory 220. When the target object is “PET bottle A”, controller 210 refers to “target object reference position” which is a reference position of “PET bottle A”. Thus, controller 210 recognizes that an average coordinate of the contact point groups of the target object with the projection plane needs to be the target object reference position. Hence, controller 210 calculates an average value of the coordinate values of contact point groups 175a to 175e (point 175ave in FIG. 13).

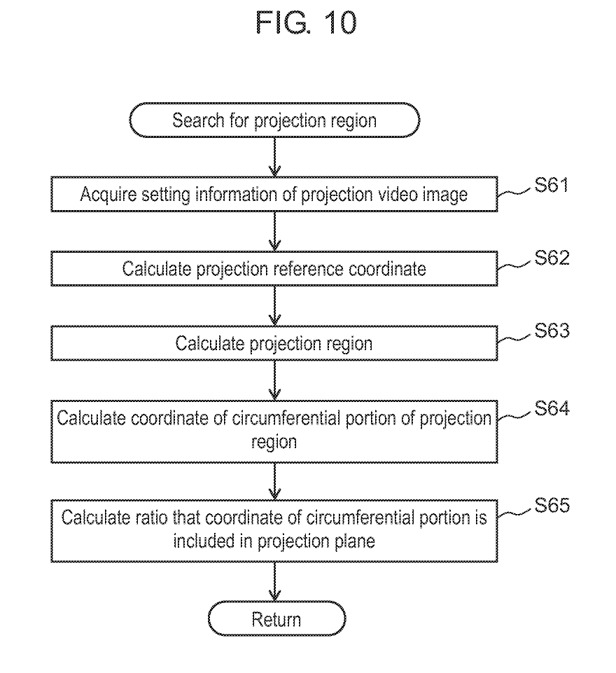

Next, controller 210 searches for a region of projection plane 153 on which a video image needs to be projected (step S6). FIG. 10 is a flowchart illustrating details of projection region search processing (step S6).

Controller 210 first refers to video image setting reference table 221 held in memory 220. When the target object is “PET bottle A”, controller 210 acquires information related to the target object “PET bottle A” from video image setting reference table 221. Thus, controller 210 acquires various pieces of setting information (a projection video image reference position, a set projection position, a projection video image inclination angle and a set projection size) related to the video image which needs to be projected (step S61). Further, controller 210 refers to projection content database 223, and acquires information of content which needs to be projected for the target object of “PET bottle A”.

Next, controller 210 calculates a projection reference coordinate according to the information acquired in step S61 (step S62). The projection reference coordinate refers to a coordinate value of a position which is a reference of a region on which a video image is projected. Controller 210 calculates a projection reference coordinate based on the projection video image reference position and the set projection position among the various pieces of setting information related to the video image which needs to be projected. When, for example, a target object is “PET bottle A”, as illustrated in FIG. 13, a coordinate value of point 181a which is 200 mm apart from average coordinate 175ave of the contact point groups in the 90-degree direction is the projection reference coordinate (projection reference position).

Next, controller 210 calculates a region (projection candidate region) on which the video image needs to be projected, based on the information acquired in step S61 and the projection reference coordinate calculated in step S62 (step S63).

When a target object is “PET bottle A”, as illustrated in FIG. 13, a rectangular region whose vertical sides/horizontal sides are 100 mm/100 mm around projection reference coordinate 181a and whose inclination angle is 0 degrees is specified as a projection candidate region.

Then, controller 210 calculates a coordinate value of each point which forms a peripheral edge portion (e.g. side 181c) of the projection candidate region, from the distance information acquired in step S1 (step S64).

Next, controller 210 determines whether or not each coordinate value of each point which forms the peripheral edge portion calculated in step S64 is included in projection plane 153. For example controller 210 calculates the coordinate value of each point which forms the peripheral edge portion, from the distance information of the portion corresponding to the peripheral edge portion, and calculates a distance between the calculated coordinate value and projection plane 153. Further, when the calculated distance is zero or nearly zero, controller 210 determines that a point is included in projection plane 153. Alternatively, controller 210 may calculate a coordinate value of each point which forms the portion, from the distance information of the portion corresponding to the peripheral edge portion, substitute the coordinate value in a plane equation and determine whether or not the plane equation is established. Further, controller 210 calculates a result of the determination, and calculates a ratio of coordinate values included in the projection plane among coordinate values at the peripheral edge portion of the projection candidate region (step S65). In addition, calculation of the ratio in this step is not limited to calculation of a ratio related to coordinates of the peripheral edge portion of the projection candidate region. For example, the ratio may be a ratio of an area of the projection candidate region included in the projection plane which occupies in an area of the entire projection candidate region. Further, only a ratio of an apex of the projection candidate region (e.g. point 181b in FIG. 13) included in the projection plane may be calculated.

Back to FIG. 9, controller 210 determines whether or not a video image can be projected on a projection candidate region calculated in step S6, based on the ratio calculated in step S65 (step S7). When, for example, the ratio calculated in step S65 is a predetermined value or more, controller 210 determines that the video image can be projected on a projection, candidate region. The predetermined value may be an arbitrary value of 0% to 100%. The predetermined value may be set by a user. When the predetermined value is 0%, controller 210 determines that the video image can be projected on the projection candidate region at all times. When the predetermined value is 100%, controller 210 determines that a video image can be projected on the projection candidate region only when the projection candidate region is fully included in projection plane 153.

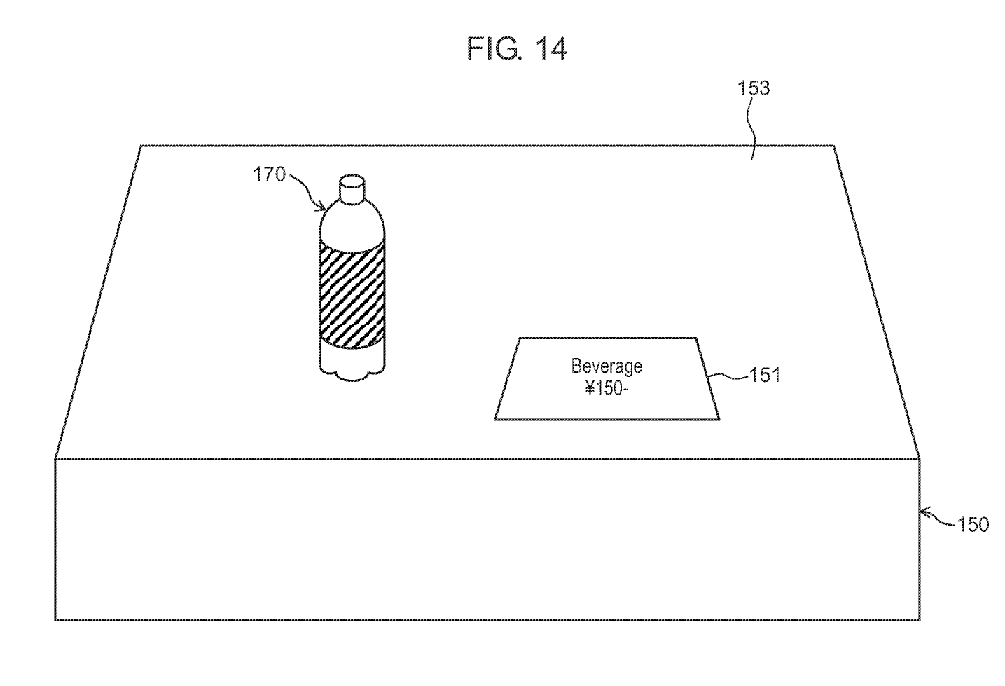

When it is determined that the video image can be projected (“YES” in step S7), controller 210 controls light source unit 300, video image generator 400 and projection optical system 500, and projects a video image (content) associated with the target object (PET bottle 170) on the projection candidate region. In addition, in this case, controller 210 may perform processing of geometrically correcting video image data held in projection content database 223 to display the video image having the correct shape while projecting the video image on the projection plane. FIG. 14 illustrates an example of a video image displayed near PET bottle 170 which is a target object.

On the other hand, when it is determined that the video image cannot be projected (“NO” in step S7), the video image is not projected. Meanwhile, controller 210 may discard the projection candidate region on which the video image cannot be projected, and search again for a region on which a video image can be projected. In a case where, for example, a plurality of positional relationships is prioritized and defined to “set projection positions” of video image setting reference table 221, a new projection candidate region may be searched for by using a positional relationship of the second highest priority of the projection candidate region for which it has been determined that the video image cannot be projected. Alternatively, for example, a size of a video image which needs to be projected may be made smaller than a setting value, a projection candidate region may be calculated again and the video image having a size which can be projected may also be projected.

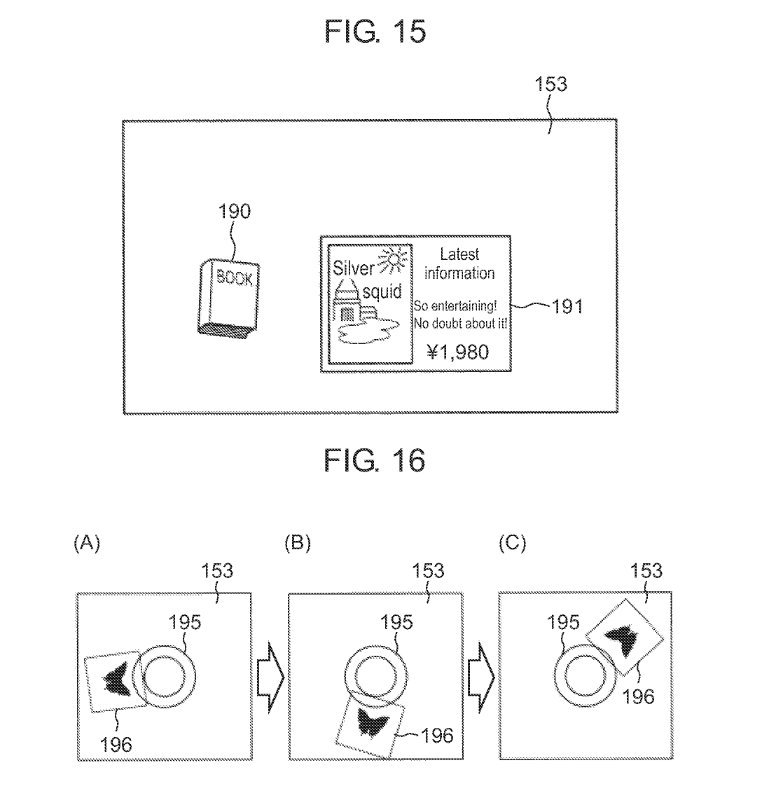

FIG. 15 is a view illustrating another example of a video image projected near a target object. This example corresponds to a case where “target object” in video image setting reference table 221 illustrated in FIG. 7 is “book B”. When detecting book 190 placed on projection plane 153, projector device 100 can display video image content 191 which introduces book 190 at a right side.

FIG. 16 is a view illustrating still another example of a video image projected near a target object. This example corresponds to a case where “target object” in video image setting reference table 221 illustrated in FIG. 7 is “dish C”. When detecting dish 195 placed on projection plane 153, projector device 100 can display moving video image 196 of a butterfly flying around dish 195 in order of FIGS. 16(A), (B) and (C).

[1-4. Effect and Others]

As described above, projector device 100 according to the present exemplary embodiment includes a distance sensor (distance detector 230) which measures a distance to a facing object, a detector (controller 210) which detects a specific target object and a projection plane which is in contact with the target object, based on distance information output from the distance sensor, a projection region determination unit (controller 210) which specifies a contact portion at which the target object and the projection plane are in contact, and determines a region on which a video image which is associated with the target object can be projected, in the projection plane based on the specified contact portion, and a projector (light source unit 300, video image generator 400 and projection optical system 500) which projects a video image on a region, and can reliably project a video image on the region having an intended positional relationship with the target object. Projector device 100 in particular can reliably project a video image on a region having the intended positional relationship with the target object even when the projection plane is disposed obliquely with respect to projector device 100.

### Another Exemplary Embodiment

In the first exemplary embodiment, a case where controller 210 is a semiconductor element has been described. Controller 210 may include, for example, a CPU (Central Processing Unit) and an auxiliary circuit of the CPU. Controller 210 performs the above operation by executing various types of processing according to a program and data stored in memory 220. In addition, controller 210 can also be mounted as a processor such as a programmable logic device such as an ASIC (Application Specific Integrated Circuit) or a FPGA (Field-Programmable Gate Array) or a micro controller.

In the first exemplary embodiment, a case where distance detector 230 is a TOF sensor has been described. However, distance detector 230 is by no means limited to the TOF sensor. Distance detector 230 may be a device which can measure a distance to a facing object.

In the first exemplary embodiment, an example where video image content including character information is projected near PET bottle 170 (target object) placed on top plane 153 (projection plane) of table 150 has been described as an example where a specific video image is projected near a target object. However, a projection plane is not limited to table 150. The projection plane may be wall 140 as illustrated in, for example, FIG. 1, and, in this case, painting 160 hung on wall 140 may be a target object. Further, a video image to be projected may not be a video image including specific information. Projector device 100 can perform an operation of illuminating a target object with a specific color (including black (no illumination), too. In this regard, illuminating a target object with black includes illuminating surroundings of the target object, and not illuminating, i.e., outlining only the target object.

The exemplary embodiments have been described as an exemplary technique according to the present disclosure. Hence, the accompanying drawings and detailed description have been provided.

Accordingly, the components illustrated in the accompanying drawings and described in the detailed description include not only indispensable components but also components which are not indispensable to exemplify the above technique. Hence, it should not be acknowledged that those components which are not indispensable are illustrated in the accompanying drawings and described in the detailed description mean that those indispensable components which are not indispensable are indispensable.

Further, the above exemplary embodiments exemplify the technique according to the present disclosure, and therefore can be variously change replaced, added and omitted within a scope of the claims or a scope equivalent to the claims.

The present disclosure is applicable to a projector device which projects a video image to an intended position associated with a specific body.

What is claimed is:

1. A projector device comprising:
a distance sensor which measures a distance to a facing object,
a detector which detects a specific target object and a projection plane which is in contact with the target object, based on distance information output from the distance sensor;
a projection region determination unit which specifies a contact portion at which the target object and the projection plane are in contact, and determines a region on which a video image which is associated with the target object can be projected, in the projection plane based on the specified contact portion; and
a projector which projects the video image to the region.

2. The projector device according to claim 1, wherein the projection region determination unit deter determines the region based on the contact portion and, in addition, a size of the video image when the video image is projected.

3. The projector device according to claim 2, wherein, when a ratio of a peripheral edge portion included in the projection plane among peripheral edge portions of the video image when the video image is projected to the region is a predetermined value or more, the projection region determination unit determines that the video image can be projected to the region.

4. The projector device according to claim 1, wherein the distance sensor is a Time-of-Flight distance image sensor.

5. A projection method comprising:
measuring a distance to a facing object, and acquiring distance information;
detecting a specific target object and a projection plane which is in contact with the target object, based on the distance information;
specifying a contact portion at which the target object and the projection plane are in contact, and determining a region on which a video image which is associated with the target object can be projected, in the projection plane based on the specified contact portion; and
projecting the video image to the region.
